(19) United States
(12) Patent Application Publication
(10) Pub. No.: US 2012/0328953 A1
(43) Pub. Date: Dec. 27, 2012

(54) GRAPHENE, POWER STORAGE DEVICE, AND ELECTRIC APPLIANCE

(75) Inventors: Takuya HIROHASHI, Atsugi (JP); Shunsuke Adachi, Atsugi (JP)

(73) Assignee: SEMICONDUCTOR ENERGY LABORATORY CO., LTD., Atsugi-shi (JP)

(21) Appl. No.: 13/526,728

(22) Filed: Jun. 19, 2012

(30) Foreign Application Priority Data
Jun. 24, 2011 (JP) 2011-141035

(51) Int. Cl. C01B 31/00; H01M 4/583; H01B 1/04; B82Y 99/00; B82Y 30/00

(52) U.S. Cl. 429/231.8; 428/131; 423/448; 252/502; 977/734; 977/948; 977/952

(57) ABSTRACT

Graphene which is permeable to lithium ions and can be used for electric appliances is provided. A carbocyclic ring including nine or more ring members is provided in graphene. The maximum potential energy of the carbocyclic ring including nine or more ring members to a lithium ion is substantially 0 eV. Therefore, the carbocyclic ring including nine or more ring members can function as a hole through which lithium ions pass. When a surface of an electrode or an active material is coated with such graphene, reaction of the electrode or the active material with an electrolyte can be suppressed without interference with the movement of lithium ions.

### BACKGROUND OF THE INVENTION

1. Field of the Invention

The present invention relates to graphene or a plurality of layers of graphene which has excellent permeability to lithium and excellent conductivity and can be used as a material of a lithium ion secondary battery or the like. Graphene refers to one-atom-thick sheet of carbon molecules having sp² bonds.

2. Description of the Related Art

Graphene has excellent electrical characteristics such as high conductivity and high mobility and physical characteristics such as flexibility and mechanical strength, and thus has been tried to be applied to a variety of products (see Patent Documents 1 to 3). Further, a technique for applying graphene to a lithium ion secondary battery is disclosed (Patent Document 4).

### REFERENCE

[Patent Document 1] United States Published Patent Application No. 2011/0070146
[Patent Document 2] United States Published Patent Application No. 2009/0110627
[Patent Document 3] United States Published Patent Application No. 2007/0131915
[Patent Document 4] United States Published Patent Application No. 2010/0081057

### SUMMARY OF THE INVENTION

It is known that graphene has high conductivity. Graphene itself is not permeable to ions; however, when a hole (an opening) is provided in part of graphene, the graphene can have ion permeability.

When the size of a hole provided in graphene is large and the number of holes per unit area is large, the graphene has effective ion permeability, but the mechanical strength of the graphene is reduced. One embodiment of the present invention is made in view of the problem, and it is an object of one embodiment of the present invention to optimize the sizes and the number of holes provided in graphene and the mechanical strength of the graphene.

It is another object of one embodiment of the present invention to provide a power storage device with excellent charging and discharging characteristics. It is another object of one embodiment of the present invention to increase a storage capacitance per unit weight. It is another object of one embodiment of the present invention to improve cycle characteristics. It is another object of one embodiment of the present invention to provide a highly reliable electric appliance which can withstand long-term or repeated use.

In one embodiment of the present invention, a carbocyclic ring including nine or more ring members is provided in graphene. The maximum potential energy of a nine-membered carbocyclic ring to a lithium ion is substantially 0 eV. Therefore, when the carbocyclic ring including nine or more ring members is provided in graphene, the carbocyclic ring can function as a hole through which lithium ions pass.

In one embodiment of the present invention, a hole having an area of greater than or equal to 0.149 nm² is provided in graphene. In the case where the area of the hole provided in graphene is greater than or equal to 0.149 nm², lithium ions can easily pass through the graphene.

When a surface of an electrode or an active material is coated with such graphene, reaction of the electrode or the active material with an electrolyte can be suppressed without interference with the movement of lithium ions.

One embodiment of the present invention is an electric appliance including the graphene. Further, one embodiment of the present invention is an electrode or an active material whose surface is coated with the graphene. One embodiment of the present invention achieves one of the above objects.

According to one embodiment of the present invention, it is possible to improve the charge and discharge rate of a power storage device.

According to one embodiment of the present invention, it is possible to increase a storage capacity per unit weight.

According to one embodiment of the present invention, cycle characteristics can be improved.

### BRIEF DESCRIPTION OF THE DRAWINGS

In the accompanying drawings:

FIGS. 1A and 1B each illustrate an optimal structure of a carbocyclic ring formed in graphene;

FIG. 2 is a graph showing a change in potential energy which a lithium ion receives from a carbocyclic ring;

FIG. 3 is a graph showing a relation between an area a of a hole provided in graphene and an area S of graphene which includes one hole;

FIGS. 4A and 4B show the movement of a lithium ion;

FIG. 5 illustrates a structure of a coin-type secondary battery; and

FIG. 6 illustrates examples of electric appliances.

### DETAILED DESCRIPTION OF THE INVENTION

Embodiments will be described below. Note that embodiments can be carried out in many different modes, and it is easily understood by those skilled in the art that modes and details of the present invention can be modified in various ways without departing from the spirit and the scope of the present invention. Thus, the present invention should not be interpreted as being limited to the following description of the embodiments.

### Embodiment 1

A method for optimizing the size of a hole provided in graphene, the number density of the holes (the number of the holes per unit area of the graphene), and the mechanical strength of the graphene will be described in this embodiment.

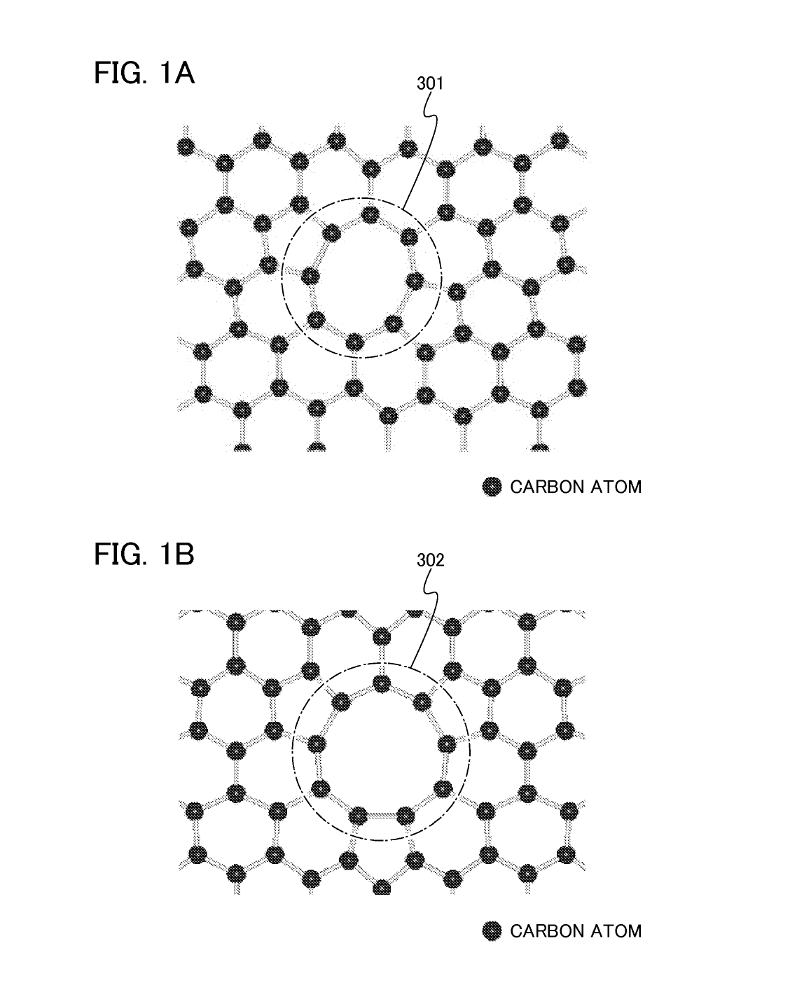

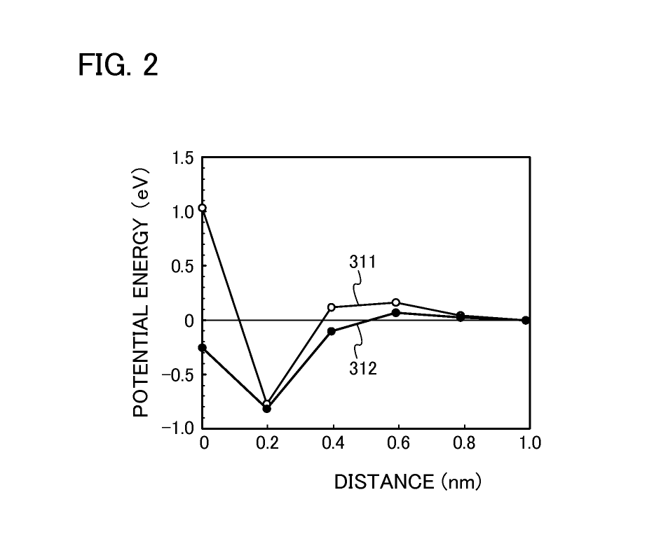

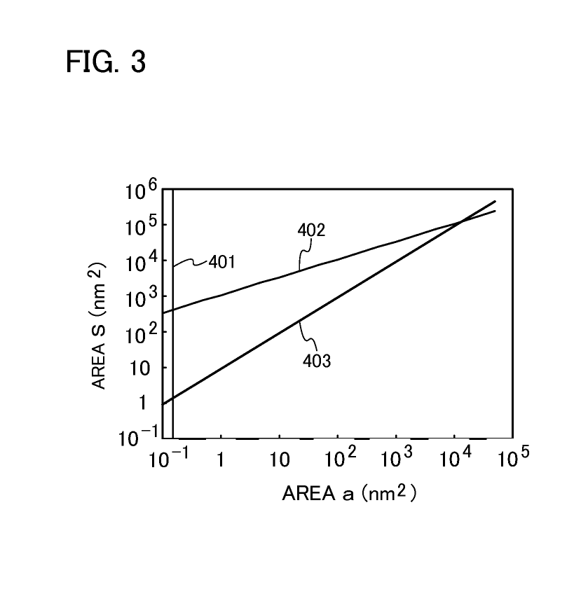

FIGS. 1A and 1B each illustrate an optimal structure of a carbocyclic ring formed in graphene. FIG. 2 shows a change in potential energy which a lithium ion receives from a carbocyclic ring having an eight-membered ring structure or a carbocyclic ring having a nine-membered ring structure. FIG. 3 shows a relation between an area a of a hole provided in the graphene and an area S of graphene including one hole (1/S corresponds to the number density) at given mechanical strength is a given value.

First, as candidates for a hole which has the minimum area and is provided in the graphane, a carbocyclic ring having an eight-membered ring structure and a carbocyclic ring having a nine-membered ring structure were given, and permeability of each of these carbocyclic rings to lithium ions was estimated by first-principle calculation. For the calculation, software of first-principle calculation VASP based on a plane wave basis pseudopotential method was used.

FIG. 1A illustrates an optimal structure of a carbocyclic ring which has an eight-membered ring structure and is formed in graphene, which is obtained by the first-principle calculation. The diameter of a carbocyclic ring 301 having an eight-membered ring structure is 0.427 nm at maximum and 0.347 nm at minimum, and the area thereof obtained by elementary geometry using a triangle is 0.105 nm².

FIG. 1B illustrates an optimal structure of a carbocyclic ring which has a nine-membered ring structure and is formed in graphene, which is obtained by the first-principle calculation. The diameter of a carbocyclic ring 302 having a nine-membered ring structure is 0.428 nm at maximum and 0.422 nm at minimum, and the area thereof obtained by elementary geometry using a triangle is 0.149 nm².

Estimation results of the lithium-ion permeability of the structures illustrated in FIGS. 1A and 1B are shown in FIG. 2. FIG. 2 shows a change in potential energy which a lithium ion receives from a carbocyclic ring, with respect to a distance between the lithium ion and the carbocyclic ring. In FIG. 2, the abscissa denotes the distance between the lithium ion and the carbocyclic ring, and the ordinate denotes the potential energy which the lithium ion receives from the carbocyclic ring. In FIG. 2, a curve 311 denotes a change in potential energy which a lithium ion receives from the carbocyclic ring 301 having an eight-membered ring structure, and a curve 312 denotes a change in potential energy which a lithium ion receives from the carbocyclic ring 302 having a nine-membered structure.

The potential energy of the carbocyclic ring 301 having an eight-membered ring structure becomes the minimum when the distance between the lithium ion and the carbocyclic ring 301 is approximately 0.2 nm, but begins to increase when the distance becomes shorter than 0.2 nm. In order that the lithium ion reaches the carbocyclic ring 301, a potential energy of approximately 1 eV is needed; therefore, the lithium ion cannot pass through the carbocyclic ring 301.

In contrast, in the case of the carbocyclic ring 302 having a nine-membered ring structure, the potential energy at the time when the lithium ion reaches the carbocyclic ring 302 having a nine-membered ring structure is approximately −0.26 eV. Therefore, the lithium ion can easily pass through the carbocyclic ring 302.

In general, potential energy needed for a lithium ion to pass through a carbocyclic ring is increased as the number of ring members in the carbocyclic ring becomes small, and is reduced as the number of rings in the carbocyclic ring becomes large. Therefore, the number of ring members in the carbocyclic ring (hole) provided in graphene needs to be greater than or equal to nine in order that a lithium ion passes through the carbocyclic ring. In short, the area a of the hole needs to be larger than a line 401 shown in FIG. 3.

A time needed for a lithium ion to pass through graphene having a hole is mainly determined by a time for the lithium ion existing on a plane of the graphene to reach the hole.

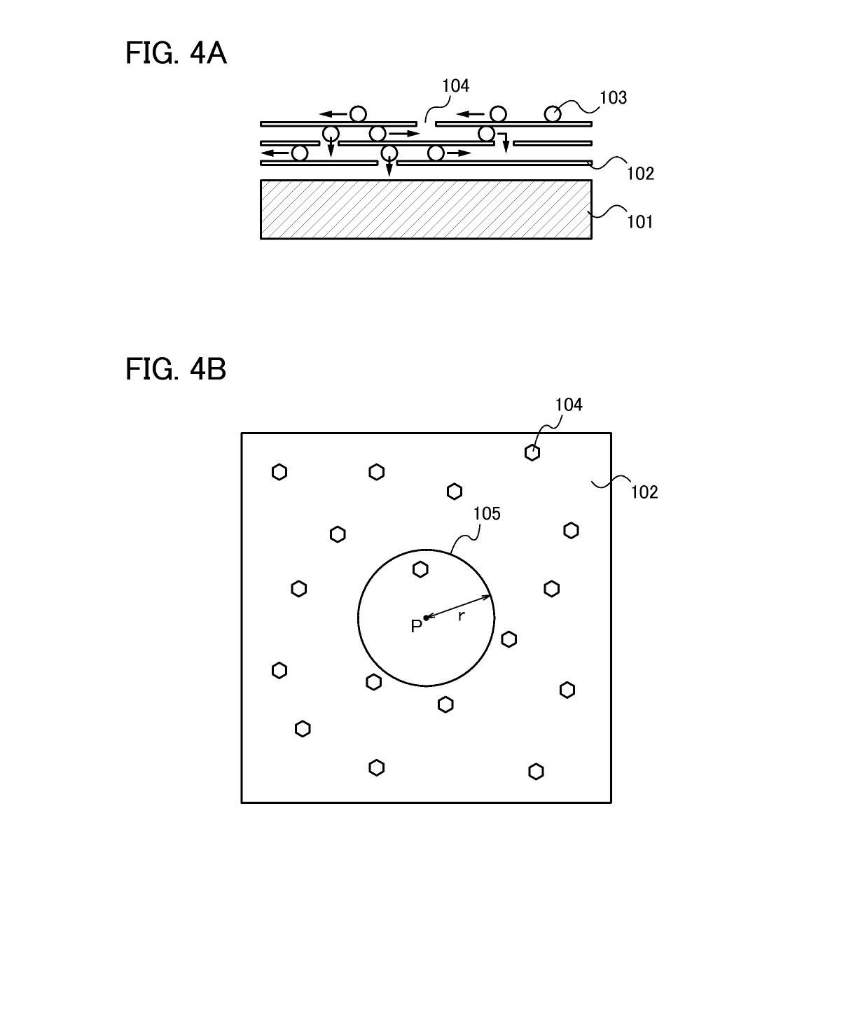

As illustrated in FIG. 4A, a lithium ion 103 moves on a plane of graphene 102. In the case where an electrode 101 (an active material in the case of a power storage device) which is in contact with the graphene 102 has a negative potential, the lithium ion 103 which reaches a hole 104 moves to a lower layer of graphene (in the case where the electrode 101 has a positive potential, the lithium ion 103 moves to an upper layer of graphene).

A time for the lithium ion which moves on the graphene 102 having the hole 104 to reach the hole 104 that is a carbocyclic ring including nine or more ring members can be calculated as described below on the basis of a model of FIG. 4B.

First, dispersion of a lithium ion existing on graphene is described. A travel distance r of the lithium ion positioned at a point P after a time t can be expressed by Formula 1 based on a relation formula between time and the mean-square displacement according to two-dimensional Brownian motion. Here, D denotes a diffusion coefficient of the lithium ion.

r=\sqrt{4Dt} [Formula 1]

In other words, the lithium ion which is positioned at the point P exists in a circle 105 whose center is the point P with a radius of r after the time t.

Next, assuming that the area (average area) of graphene which has one hole 104 which is a carbocyclic ring including nine or more ring members is S, the time for the lithium ion moving on the graphene to reach the hole 104 is examined Note that a reciprocal of S (1/S) corresponds to the number of holes 104 per unit area (the number density of holes) of the graphene 102.

Formula 2 can be obtained from Formula 1 and a formula for finding the area of a circle, where time t₀ denotes the time for the lithium ion positioned at the point P to reach the hole 104. In other words, there is a possibility that the lithium ion moving on the graphene reaches the hole 104 after the time t₀ satisfying Formula 2. Formula 3 described below is obtained by rearranging Formula 2 so that the time t₀ is the subject of the formula.

π(\sqrt{4Dt₀})²=S [Formula 2]

$${t}_{0} = \frac{S}{4 π D} \qquad [ Formula 3 ]$$

Next, a probability that the lithium ion reaches the hole 104 after the time t is examined. The probability that the lithium ion reaches the hole 104 after the time t₀ can be expressed as a/S where S denotes the area of the graphene which has one hole 104 and a denotes the area of the hole 104. In addition, a probability that the lithium ion does not reach the hole 104 after the time t₀ can be expressed as 1−a/S. Accordingly, a probability that the lithium ion does not reach the hole 104 after the time t can be expressed by Formula 4.

(1−a/S)^{t/t}^{₀} [Formula 4]

Accordingly, a probability P (t) that the lithium ion reaches the hole 104 (the lithium ion does not exist on the graphene 102) after the time t can be expressed by Formula 5.

P(t)=1−(1−a/S)^{t/t}^{₀} [Formula 5]

In the case where a/S is sufficiently small, Formula 5 can be approximated according to Taylor expansion as shown in Formula 6.

P(t)=1−(1−a/S)^{t/t}^{₀}≈at/St₀ [Formula 6]

In the case where time t₁ denotes the time when the lithium ion reaches the hole 104 (the lithium ion does not exist on the graphene 102), a probability P (t₁) that the lithium ion reaches the hole 104 at the time t₁ is 1. When Formula 3 is substituted for the time t₀ of Formula 6, the time t₁ can be expressed by Formula 7.

t₁=St₀/a=S²/4πaD [Formula 7]

Therefore, the time for the lithium ion moving on the graphene 102 having the hole 104 to reach the hole 104 having the area a can be calculated using Formula 7.

The diffusion coefficient D of the lithium ion on the plane of the graphene is 1×10⁻¹¹ cm²/s. Under the condition that the time t₁ is set to a time which is sufficiently shorter than a charge and discharge time of a battery actually used, for example, is set to shorter than or equal to 10 seconds, a line 402 in FIG. 3 can be obtained from Formula 7. Since S is to have a value less than or equal to the line 402, conditions of Formula 8 need to be satisfied.

S≦\sqrt{4πaDt₁} [Formula 8]

Naturally, as the number density of the holes is increased, the time for the lithium ion to reach the hole becomes shorter. On the other hand, as the number density of the holes is increased, the mechanical strength of the graphene is reduced. Therefore, it is necessary to set the upper limit of the number density of the holes.

Mechanical strength against extension or compression in the one-dimensional direction is determined by the proportion of holes in graphene in the one-dimensional direction. The mechanical strength in the one-dimensional direction U can be approximately obtained from Formula 9.

U=1−\sqrt{a/S} [Formula 9]

For example, in order to ensure mechanical strength which is k times (k<1, k is a ratio with respect to mechanical strength of graphene which has no hole) as large as the mechanical strength of the graphene in the one-dimensional direction, the proportion of holes in the graphene in the one-dimensional direction is increased by (1−k) times. That is, the proportion of the holes in the graphene in the two-dimensional direction may be set to (1−k)² times as large as the area S. From these conditions, a line 403 in FIG. 3 is determined. Since S is to have a value greater than or equal to the line 403, conditions of Formula 10 need to be satisfied. Note that the line 403 represents the case where k is ⅔.

$$S \geq \frac{1}{{( 1 - k )}^{2}} a \qquad [ Formula 10 ]$$

FIG. 3, Formula 9, and Formula 10 show the case where the graphene is one layer; however, also in the case of a stack of a plurality of layers of graphene, lines 402 and 403 in FIG. 3 can be determined in consideration of the content disclosed in this embodiment.

In addition, the hole provided in the graphene is not limited to a carbocyclic ring, and a cyclic compound structure including carbon and one or plural kinds of elements selected from oxygen, nitrogen, and sulfur can be employed.

In this manner, the area a and the area S are set within a range surrounded by the line 401 to the line 403 shown in FIG. 3, whereby, the sizes and the number density of the holes provided in the graphene can be optimized when mechanical strength has a given value.

The application of an electrode or an active material which is coated with the above graphene to a power storage device makes it possible to improve the charge and discharge rate of the power storage device. Further, it is possible to increase a storage capacity per unit weight of the power storage device. Furthermore, it is possible to improve the cycle characteristics of the power storage device.

This embodiment can be implemented in combination with any of the other embodiments as appropriate.

### Embodiment 2

In this embodiment, an example of forming a graphane layer including 1 to 50 layers of graphene on a surface of a silicon particle will be described. First, graphite oxide is prepared by oxidizing graphite and then subjected to ultrasonic vibration to give graphene oxide. For details, Patent Document 2 may be referred to. Alternatively, commercially available graphene oxide may be used.

Next, the graphene oxide is mixed with silicon particles. The proportion of graphene oxide may be set in the range from 1 wt. % to 15 wt. %, preferably from 1 wt. % to 5 wt. % of the total. Furthermore, the mixture is heated at 150° C. or higher, preferably 200° C. or higher, in vacuum or a reducing atmosphere such as an inert gas (e.g., nitrogen or a rare gas) atmosphere. By being heated at a higher temperature, graphene oxide is reduced to a higher extent so that graphene with high purity (i.e., with a low concentration of elements other than carbon) can be obtained. Note that graphene oxide is known to be reduced at 150° C.

Note that high-temperature treatment is preferable in order to obtain graphene having high electron conductivity. For example, the resistivity of multilayer graphene is approximately 240 MΩcm at a heating temperature of 100° C. (for 1 hour), approximately 4 kΩcm at a heating temperature of 200° C. (for 1 hour), and approximately 2.8 Ωcm at a heating temperature of 300° C. (for 1 hour).

In this manner, graphene oxide formed over the surfaces of the silicon particles is reduced to be graphene. At that time, adjacent graphenes are bonded to each other to form a huge net-like or sheet-like network (graphene net). Since the graphene formed in this manner has holes in the above-described number density, lithium ions pass through the graphene.

The silicon particles having been subjected to the above treatments are dispersed in an appropriate solvent (preferably a polar solvent such as water, chloroform, N,N-dimethylformamide (DMF), or N-methylpyrrolidone (NMP)) to obtain slurry. A secondary battery can be manufactured using the slurry.

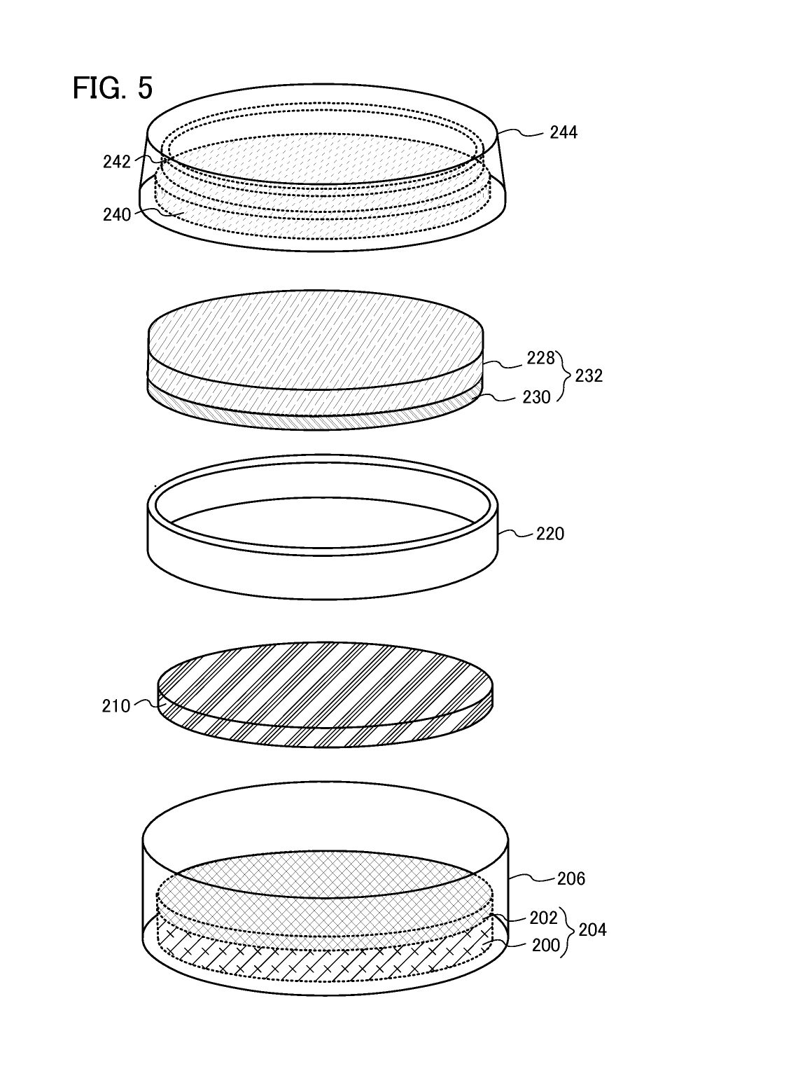

FIG. 5 shows the structure of a coin-type secondary battery. As illustrated in FIG. 5, the coin-type secondary battery includes a negative electrode 204, a positive electrode 232, a separator 210, an electrolyte (not illustrated), a housing 206, and a housing 244. Besides, the coin-type secondary battery includes a ring-shaped insulator 220, a spacer 240, and a washer 242.

The negative electrode 204 includes a negative electrode active material layer 202 over a negative electrode collector 200. As the negative electrode collector 200, copper is used, for example. The negative electrode active material layer 202 is preferably formed using, as a negative electrode active material, the above slurry alone or the above slurry in combination with a binder.

As a material of the positive electrode collector 228, aluminum is preferably used. A positive electrode active material layer 230 may be formed in such a manner that slurry in which positive electrode active material particles, a binder, and a conduction auxiliary agent are mixed is applied on the positive electrode collector 228 and is dried.

As the positive electrode active material, lithium cobaltate, lithium iron phosphate, lithium manganese phosphate, lithium manganese silicate, lithium iron silicate, or the like can be used; however, one embodiment of the present invention is not limited thereto. The size of the active material particles is preferably 20 nm to 100 nm. Further, a carbohydrate such as glucose may be mixed at the time of baking of the positive electrode active material particles so that the positive electrode active material particles are coated with carbon. This treatment can improve the conductivity.

The electrolyte in which LiPF₆ is dissolved in a mixed solvent of ethylene carbonate (EC) and diethyl carbonate (DEC) is preferably used; however one embodiment of the present invention is not limited hereto.

An insulator with pores (e.g., polypropylene) may be used for the separator 210. Alternatively, a solid electrolyte which permeable to lithium ions may be used.

The housing 206, the housing 244, the spacer 240, and the washer 242 each of which is made of metal (e.g., stainless steel) are preferably used. The housing 206 and the housing 244 have a function of electrically connecting the negative electrode 204 and the positive electrode 232 to the outside.

The negative electrode 204, the positive electrode 232, and the separator 210 are soaked in the electrolyte solution. Then, as illustrated in FIG. 5, the negative electrode 204, the separator 210, the ring-shaped insulator 220, the positive electrode 232, the spacer 240, the washer 242, and the housing 244 are stacked in this order with the housing 206 positioned at the bottom. The housing 206 and the housing 244 are subjected to pressure bonding. In such a manner, the coin-type secondary battery is manufactured.

This embodiment can be implemented in combination with any of the other embodiments as appropriate.

### Embodiment 3

In this embodiment, an example of forming a graphene layer including 1 to 50 layers of graphene over a surface of a silicon active material layer formed over a collector will be described. First, graphene oxide is dispersed in a solvent such as water or NMP. The solvent is preferably a polar solvent. The concentration of graphene oxide may be 0.1 g to 10 g per liter.

A collector with a silicon active material layer is immersed in this solution, taken out, and then dried. Further, the collector is heated at 200° C. or higher in a vacuum or in a reducing atmosphere such as an inert gas (nitrogen, a rare gas, or the like) atmosphere. Through the above steps, a graphene layer including 1 to 50 layers of graphene can be formed over a surface of the silicon active material layer. The graphene layer formed in such a manner has holes in the above number density; therefore, lithium ions pass through the graphene layer.

Note that after the graphene layer is formed once in this manner, another graphene layer including 1 to 50 layers of graphene may be formed by repeating the above process. The process may be repeated three or more times. When such multiple layers of graphene are formed, the strength of the whole graphene layer is increased.

In the case where a thick graphene layer is formed at a time, the directions of sp² bonds in the graphene become random, and the strength of the graphene layer is not proportional to the thickness thereof. In contrast, in the case where the graphene layer is formed through a plurality of steps as described above, the directions of sp² bonds in the graphene are substantially parallel to a silicon surface; thus, the strength of the graphene layer increases as the thickness increases.

This embodiment can be implemented in combination with any of the other embodiments as appropriate.

### Embodiment 4

In this embodiment, another example of forming a graphene layer including 1 to 50 layers of graphene over a surface of a silicon active material layer formed over a collector will be described. As in Embodiment 2, graphene oxide is dispersed in a solvent such as water or NMP. The concentration of graphene oxide may be 0.1 g to 10 g per liter.

A collector provided with a silicon active material layer is put in the solution in which graphene oxide is dispersed, and this is used as a positive electrode. A conductor serving as a negative electrode is put in the solution, and an appropriate voltage (e.g., 5 V to 20 V) is applied between the positive electrode and the negative electrode. In graphene oxide, part of an edge of a graphene sheet with a certain size is terminated by a carboxyl group (—COOH), and therefore, in a solvent such as water, hydrogen ions are released from the carboxyl group and graphene oxide itself is negatively charged. Thus, the graphene oxide is drawn to and deposited on the positive electrode. Note that the voltage in that case is not necessarily constant. By measurement of the amount of electric charge flowing between the positive electrode and the negative electrode, the thickness of a layer of graphene oxide deposited on the silicon active material layer can be estimated.

When a graphene oxide with a necessary thickness is obtained, the collector is taken out of the solution and dried. Further, the collector is heated at 200° C. or higher in a vacuum or in a reducing atmosphere such as an inert gas (nitrogen, a rare gas, or the like) atmosphere. In this manner, the graphene oxide formed over the surface of the silicon active material is reduced to graphene. At that time, adjacent graphenes are bonded to each other to form a huge net-like or sheet-like network (graphene net).

Even when the silicon active material has projections and depressions, the thus formed graphene has a substantially uniform thickness even at the projections and depressions. Through the above steps, a graphene layer including 1 to 50 layers of graphene can be formed over a surface of the silicon active material layer. The graphene layer formed in such a manner has holes in the above number density; therefore, lithium ions pass through the graphene layer.

Note that after the graphene layer is formed in this manner, formation of a graphene layer according to the method of this embodiment, or formation of a graphene layer according to the method of Embodiment 2 may be performed one or more times.

This embodiment can be implemented in combination with any of the other embodiments as appropriate.

### Embodiment 5

A power storage device according to one embodiment of the present invention described can be used as a power supply of various electric appliances which are driven by electric power.

Specific examples of electric appliances using the power storage device according to one embodiment of the present invention are as follows: display devices, lighting devices, desktop personal computers or laptop personal computers, image reproduction devices which reproduce a still image or a moving image stored in a recording medium such as a digital versatile disc (DVD), mobile phones, portable game machines, portable information terminals, e-book readers, video cameras, digital still cameras, high-frequency heating apparatus such as microwaves, electric rice cookers, electric washing machines, air-conditioning systems such as air conditioners, electric refrigerators, electric freezers, electric refrigerator-freezers, freezers for preserving DNA, dialysis devices, and the like. In addition, moving objects driven by an electric motor using electric power from a power storage device are also included in the category of electric appliances. As examples of the moving objects, electric vehicles, hybrid vehicles which include both an internal-combustion engine and a motor, motorized bicycles including motor-assisted bicycles, and the like can be given.

In the electric appliances, the power storage device according to one embodiment of the present invention can be used as a power storage device for supplying enough electric power for almost the whole power consumption (such a power storage device is referred to as a main power supply). Alternatively, in the electric appliances, the power storage device according to one embodiment of the present invention can be used as a power storage device which can supply electric power to the electric appliances when the supply of power from the main power supply or a commercial power supply is stopped (such a power storage device is referred to as an uninterruptible power supply). Further alternatively, in the electric appliances, the power storage device according to one embodiment of the present invention can be used as a power storage device for supplying electric power to the electric appliances at the same time as the electric power supply from the main power supply or a commercial power supply (such a power storage device is referred to as an auxiliary power supply).

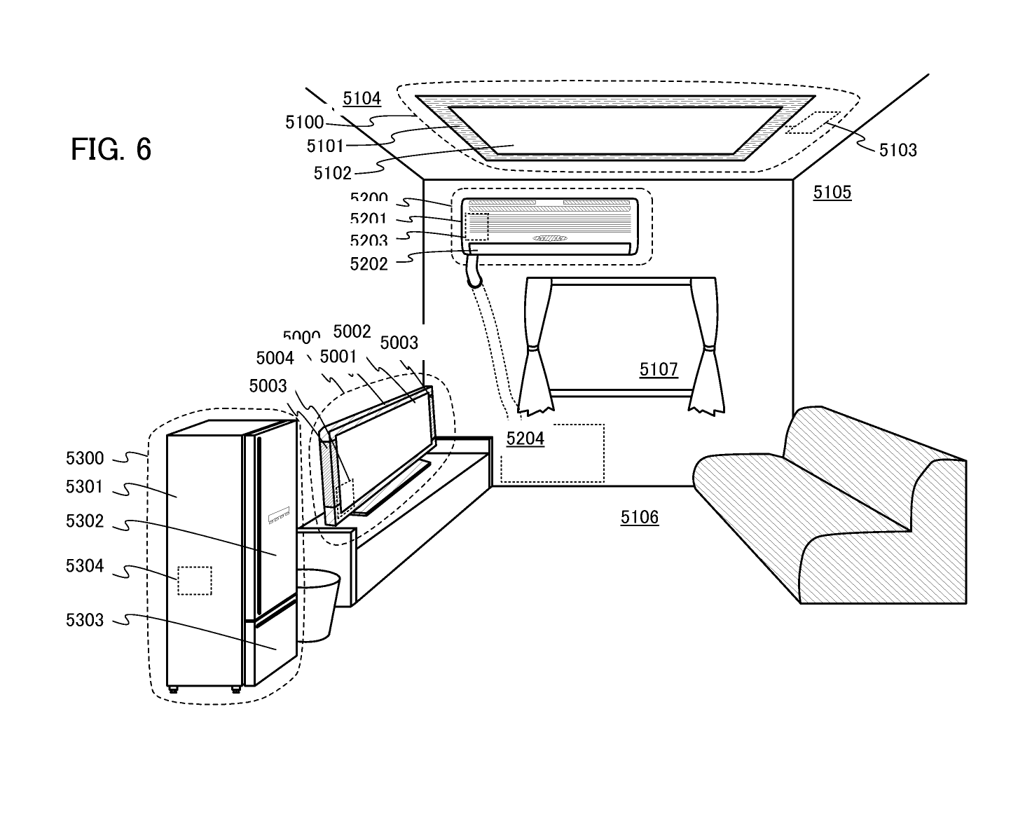

FIG. 6 shows specific structures of the electric appliances. In FIG. 6, a display device 5000 is an example of an electric appliance including a power storage device 5004 according to one embodiment of the present invention. Specifically, the display device 5000 corresponds to a display device for TV broadcast reception and includes a housing 5001, a display portion 5002, speaker portions 5003, the power storage device 5004, and the like. The power storage device 5004 according to one embodiment of the present invention is provided inside the housing 5001. The display device 5000 can receive electric power from a commercial power supply. Alternatively, the display device 5000 can use electric power stored in the power storage device 5004. Thus, the display device 5000 can be operated with the use of the power storage device 5004 according to one embodiment of the present invention as an uninterruptible power supply even when electric power cannot be supplied from the commercial power supply due to power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), a field emission display (FED), and the like can be used for the display portion 5002.

Note that the display device includes, in its category, all of information display devices for personal computers, advertisement displays, and the like other than TV broadcast reception.

In FIG. 6, an installation lighting device 5100 is an example of an electric appliance including a power storage device 5103 according to one embodiment of the present invention. Specifically, the lighting device 5100 includes a housing 5101, a light source 5102, the power storage device 5103, and the like. FIG. 6 shows the case where the power storage device 5103 is provided in a ceiling 5104 on which the housing 5101 and the light source 5102 are installed; alternatively, the power storage device 5103 may be provided in the housing 5101. The lighting device 5100 can receive electric power from the commercial power supply. Alternatively, the lighting device 5100 can use electric power stored in the power storage device 5103. Thus, the lighting device 5100 can be operated with the use of the power storage device 5103 according to one embodiment of the present invention as an uninterruptible power supply even when electric power cannot be supplied from the commercial power supply because of power failure or the like.

Note that although the installation lighting device 5100 provided in the ceiling 5104 is shown in FIG. 6 as an example, the power storage device according to one embodiment of the present invention can be used in an installation lighting device provided in, for example, a wall 5105, a floor 5106, a window 5107, or the like other than the ceiling 5104. Alternatively, the power storage device can be used in a tabletop lighting device and the like.

As the light source 5102, an artificial light source which provides light artificially by using electric power can be used. Specifically, a discharge lamp such as an incandescent lamp and a fluorescent lamp, and a light-emitting element such as an LED and an organic EL element are given as examples of the artificial light source.

In FIG. 6, an air conditioner including an indoor unit 5200 and an outdoor unit 5204 is an example of an electric appliance including a power storage device 5203 according to one embodiment of the present invention. Specifically, the indoor unit 5200 includes a housing 5201, a ventilation duct 5202, the power storage device 5203, and the like. FIG. 6 shows the case where the power storage device 5203 is provided in the indoor unit 5200; alternatively, the power storage device 5203 may be provided in the outdoor unit 5204. Further alternatively, the power storage devices 5203 may be provided in both the indoor unit 5200 and the outdoor unit 5204. The air conditioner can receive electric power from the commercial power supply. Alternatively, the air conditioner can use electric power stored in the power storage device 5203. Specifically, in the case where the power storage devices 5203 are provided n both the indoor unit 5200 and the outdoor unit 5204, the air conditioner can be operated with the use of the power storage device 5203 according to one embodiment of the present invention as an uninterruptible power supply even when electric power cannot be supplied from the commercial power supply due to power failure or the like.

Note that although the separated air conditioner including the indoor unit and the outdoor unit is shown in FIG. 6 as an example, the power storage device according to one embodiment of the present invention can be used in an air conditioner in which the functions of an indoor unit and an outdoor unit are integrated in one housing.

In FIG. 6, an electric refrigerator-freezer 5300 is an example of an electric appliance including a power storage device 5304 according to one embodiment of the present invention. Specifically, the electric refrigerator-freezer 5300 includes a housing 5301, a door for a refrigerator 5302, a door for a freezer 5303, and the power storage device 5304. The power storage device 5304 is provided in the housing 5301 in FIG. 6. Alternatively, the electric refrigerator-freezer 5300 can receive electric power from the commercial power supply or can use power stored in the power storage device 5304. Thus, the electric refrigerator-freezer 5300 can be operated with the use of the power storage device 5304 according to one embodiment of the present invention as an uninterruptible power supply even when electric power cannot be supplied from the commercial power supply because of power failure or the like.

Note that among the electric appliances described above, a high-frequency heating apparatus such as a microwave and an electric appliance such as an electric rice cooker require high electric power in a short time. The tripping of a circuit breaker of a commercial power supply in use of electric appliances can be prevented by using the power storage device according to one embodiment of the present invention as an auxiliary power supply for supplying electric power which cannot be supplied enough by a commercial power supply.

In addition, in a time period when electric appliances are not used, specifically when the proportion of the amount of power which is actually used to the total amount of power which can be supplied by a commercial power supply source (such a proportion referred to as usage rate of power) is low, power can be stored in the power storage device, whereby the usage rate of power can be reduced in a time period when the electric appliances are used. In the case of the electric refrigerator-freezer 5300, electric power can be stored in the power storage device 5304 at night time when the temperature is low and the door for a refrigerator 5302 and the door for a freezer 5303 are not opened and closed. The power storage device 5304 is used as an auxiliary power supply in daytime when the temperature is high and the door for a refrigerator 5302 and the door for a freezer 5303 are opened and closed; thus, the usage rate of electric power in daytime can be reduced.

This embodiment can be implemented in combination with any of the above embodiments as appropriate.

This application is based on Japanese Patent Application serial no. 2011-141035 filed with Japan Patent Office on Jun. 24, 2011, the entire contents of which are hereby incorporated by reference.

What is claimed is:

1. Graphene comprising a hole, wherein an area S of the graphane comprising the hole satisfies Formula 1 and Formula 2 described below:
$$\begin{matrix}S \leq \sqrt{4 π {aDt}_{1}} & [ Formula 1 ] \\ S \geq \frac{1}{{( 1 - k )}^{2}} a & [ Formula 2 ]\end{matrix}$$
wherein a denotes an area of the hole, D denotes a diffusion coefficient of a lithium ion, t₁ denotes a time for an ion on the graphene to reach the hole, and k denotes a ratio with respect to mechanical strength of graphane having no hole.

2. The graphene according to claim 1, wherein the hole is a carbocyclic ring including nine or more ring members.

3. The graphene according to claim 1, wherein the area of the hole is 0.149 nm² or more.

4. A power storage device comprising the graphene according to claim 1.

5. An electric appliance comprising the graphene according to claim 1.

6. The electric appliance according to claim 5, wherein the electric appliance is selected from the group consisting of a display device, a lighting device, a desktop personal computer, a laptop personal computer, an image reproduction device which reproduces a still image or a moving image stored in a recording medium such as a digital versatile disc, a mobile phone, a portable game machine, a portable information terminal, an e-book reader, a video camera, a digital still camera, a microwave, an electric rice cooker, an electric washing machine, an air-conditioning system, an electric refrigerator, an electric freezer, an electric refrigerator-freezer, a freezer for preserving DNA, a dialysis device, an electric vehicle, a hybrid vehicle which include both an internal-combustion engine and a motor, and a motorized bicycle including motor-assisted bicycle.

7. An electrode coated with a grapheme comprising a hole,
wherein an area S of the graphane comprising the hole satisfies Formula 1 and Formula 2 described below:
$$\begin{matrix}S \leq \sqrt{4 π {aDt}_{1}} & [ Formula 1 ] \\ S \geq \frac{1}{{( 1 - k )}^{2}} a & [ Formula 2 ]\end{matrix}$$
wherein a denotes an area of the hole, D denotes a diffusion coefficient of a lithium ion, t₁ denotes a time for an ion on the graphene to reach the hole, and k denotes a ratio with respect to mechanical strength of graphane having no hole.

8. The electrode according to claim 7, wherein the hole is a carbocyclic ring including nine or more ring members.

9. The electrode according to claim 7, wherein the area of the hole is 0.149 nm² or more.

10. A power storage device comprising the electrode according to claim 7.

11. An electric appliance comprising the electrode according to claim 7.

12. The electric appliance according to claim 11, wherein the electric appliance is selected from the group consisting of a display device, a lighting device, a desktop personal computer, a laptop personal computer, an image reproduction device which reproduces a still image or a moving image stored in a recording medium such as a digital versatile disc, a mobile phone, a portable game machine, a portable information terminal, an e-book reader, a video camera, a digital still camera, a microwave, an electric rice cooker, an electric washing machine, an air-conditioning system, an electric refrigerator, an electric freezer, an electric refrigerator-freezer, a freezer for preserving DNA, a dialysis device, an electric vehicle, a hybrid vehicle which include both an internal-combustion engine and a motor, and a motorized bicycle including motor-assisted bicycle.

13. An active material coated with a grapheme comprising a hole,
wherein an area S of the graphane comprising the hole satisfies Formula 1 and Formula 2 described below:
$$\begin{matrix}S \leq \sqrt{4 π {aDt}_{1}} & [ Formula 1 ] \\ S \geq \frac{1}{{( 1 - k )}^{2}} a & [ Formula 2 ]\end{matrix}$$
wherein a denotes an area of the hole, D denotes a diffusion coefficient of a lithium ion, t₁ denotes a time for an ion on the graphene to reach the hole, and k denotes a ratio with respect to mechanical strength of graphane having no hole.

14. The active material according to claim 13, wherein the hole is a carbocyclic ring including nine or more ring members.

15. The active material according to claim 13, wherein the area of the hole is 0.149 nm² or more.

16. A power storage device comprising the active material according to claim 13.

17. An electric appliance comprising the active material according to claim 13.

18. The electric appliance according to claim 17, wherein the electric appliance is selected from the group consisting of a display device, a lighting device, a desktop personal computer, a laptop personal computer, an image reproduction device which reproduces a still image or a moving image stored in a recording medium such as a digital versatile disc, a mobile phone, a portable game machine, a portable information terminal, an e-book reader, a video camera, a digital still camera, a microwave, an electric rice cooker, an electric washing machine, an air-conditioning system, an electric refrigerator, an electric freezer, an electric refrigerator-freezer, a freezer for preserving DNA, a dialysis device, an electric vehicle, a hybrid vehicle which include both an internal-combustion engine and a motor, and a motorized bicycle including motor-assisted bicycle.
